(19) United States
(12) Patent Application Publication
(10) Pub. No.: US 2004/0066528 A1
(43) Pub. Date: Apr. 8, 2004

(54) Methods and systems for gathering device data using the internet

(76) Inventors: Gregory Nutt, Boise, ID (US); Letty Nutt, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/269,212

(22) Filed: Oct. 3, 2002

(51) Int. Cl. G06K 1/00; G06F 15/00

(52) U.S. Cl. 358/1.15; 358/402

(57) ABSTRACT

Systems and methods for gathering data corresponding to computing devices using the Internet. The system includes a data-gathering system comprised of a program that is downloaded to a computer via the Internet. The program operates to identify a device communicating with the computer, gather data from the device and enable the data to be communicated via the Internet.

The method for gathering data corresponding to a device using the Internet can also be implemented. The method includes enabling downloading a program to a computer via the Internet, the program being operative to identify a device communicating with the computer, gather data from the device identified and enable the data to be communicated via the Internet.

### TECHNICAL FIELD

The present invention is generally related to computers, and, more particularly, to systems and methods for gathering data corresponding to devices by using the Internet.

### DESCRIPTION OF THE RELATED ART

Typically, computing devices, e.g. personal computers, printers, fax machines and copying machines, are supported by support and service infrastructures. In order for the support and service infrastructure to support these computing devices, data are gathered to determine their status, configuration, capabilities, functions, commands, etc. In the past, these data have been gathered by providing a function in the computing device that prints the data to hardcopy. The hardcopy containing the data is then faxed to the support and service infrastructure so that the data may be used for maintaining and/or troubleshooting the computing device.

Another way of gathering data from a computing device involves the use of a host-based solution that involves a peripheral computer. In such a solution, a program is installed in the peripheral computer and performs a function of gathering data from the computing device. The program may then send the data to a support and service infrastructure for maintenance, repair and/or troubleshooting. However, a user may not install or use the program because the program requires considerable dedicated disk space for execution. In addition, installing the program in the peripheral computer may be expensive and time consuming.

Another way of gathering data from a computing device involves the use of a device-base solution that can be implemented with an onboard-embedded web server (EWS). An EWS provides a highly flexible platform for delivering input/output (I/O) device-related functionality to manage many aspects of the computing device, such as view consumable life, configure network parameters, view serial number information, usage information, status information, capabilities information, functions information, and commands information. An EWS may be found in I/O devices and typically is an integral part of the devices. The EWS may gather data corresponding to the computing device and sends the data to a support and service infrastructure. However, the computing device is required to support the onboard EWS, which implies that products (e.g., legacy) without onboard EWS cannot be a part of the support and service infrastructure.

Thus, a heretofore unaddressed need exists in the industry to address the aforementioned and/or other perceived deficiencies and inadequacies.

### SUMMARY OF THE INVENTION

The present invention involves gathering data corresponding to computing devices using the Internet. Briefly described, one embodiment of the system, among others, includes a data-gathering system comprised of at least a program that is downloaded to a computer via the Internet. The program operates to identify a device communicating with the computer, gather data from the device and enable the data to be communicated via the Internet.

Embodiments of the present invention can also be viewed as methods for gathering data corresponding to a device using the Internet. In this regard, one such embodiment includes enabling downloading at least a program to a computer via the Internet, the program being operative to identify a device communicating with the computer, gather data from the device identified and enable the data to be communicated via the Internet.

The present invention can also be implemented via a computer-readable medium having a computer program for gathering device data using the Internet. The computer-readable medium comprises logic configured to identify a device communicating with a computer, logic configured to gather data from the device; and logic configured to communicate the data from the computer to a server.

Other systems, methods, features, and advantages of the present invention will be or will become apparent to one with skill in the art upon examination of the following drawings and detailed description. It is intended that all such additional systems, methods, features and advantages be included within this description, be within the scope of the present invention and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of an embodiment of the system for gathering data corresponding to a device using the Internet.

FIG. 2 is a flowchart of the top-level functional operation of the system for gathering data corresponding to a device using the Internet.

FIG. 3 is a block diagram illustrating a general-purpose computer that can implement the server computer for gathering data corresponding to a device using the Internet.

FIG. 4 is a flowchart of a user's perspective when using the system for gathering data corresponding to a device using the Internet.

FIG. 5 is a flowchart of the functionality of the system for gathering data corresponding to a device using the Internet.

FIG. 6 is a flowchart of a server's perspective when executing the system for gathering data corresponding to a device using the Internet.

### DETAILED DESCRIPTION

Systems and methods for gathering data in accordance with the invention enable support services to gather data that is used to maintain, troubleshoot and/or repair computing devices. As used herein, a “computing device” is a device that can communicate with a computer in a network, direct connection or via the Internet. By way of example, computers, fax machines, copying machines, and I/O devices are computing devices.

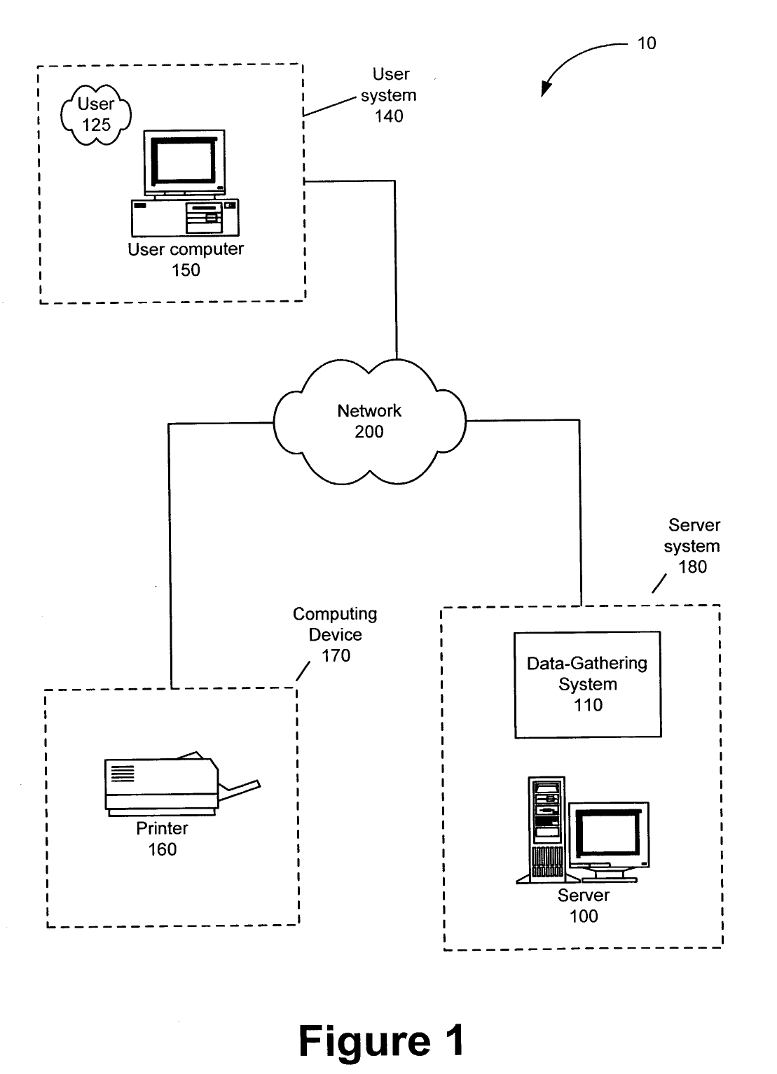

FIG. 1 is a block diagram of an embodiment of the system for gathering device data using the Internet. The system 10 includes a server system 180, a user system 140, and a computing device 170. The server system 180 includes a server 100 and a data-gathering system 110. The user system 140 includes one or more computers 150. The computing device 170 includes printer 160 and other devices described above.

The system 10 comprises a data-gathering system 110 that includes a first program that is enabled to be downloaded to user system 140 via the Internet. The first program operates to gather data from computing device 170 and enables the data to be communicated via the Internet. Before the first program gathers data from the computing device 170, the data-gathering system 110 may first need to identify the computing device 170 communicating with the user system 140. Thus, the data-gathering system 110 may further comprise a second program that is enabled to be downloaded to the user system 140 via the Internet. The second program operates to identify the computing device 170 before the first program is enabled to be downloaded. The second program identifies the computing device 170 by discovering the communication link of the computing device 170 with the user system 140, such as IP address and port, and the identity of the computing device 170.

The data-gathering system 110 may not need the second program to be downloaded into user system 140 in order to identify the device communicating with the user system 140. The data-gathering system 110 may request from a user 125 the information on the communication link of the computing device 170 with the user system 140 and the identity of the computing device 170. By requesting the user 125 to provide information to identify the computing device 170, the data-gathering system 110 need not operate the second program.

After identifying the computing device 170 via the second program or the user 125, the data-gathering system 110 may select a first program that directly corresponds to the identified computing device. The selecting of the first program allows the data-gathering system to concentrate its codes on the identified computing device 170 and thus, requires a smaller amount of system resources than codes that are developed for both identified and non-identified computing device 170. Thus, the first program can be as small as 50 Kilobytes.

The data-gathering system 110 can also be implemented with one program that can identify the computing device 170, gather data corresponding to the device 170, and enable the data to be communicated via the Internet.

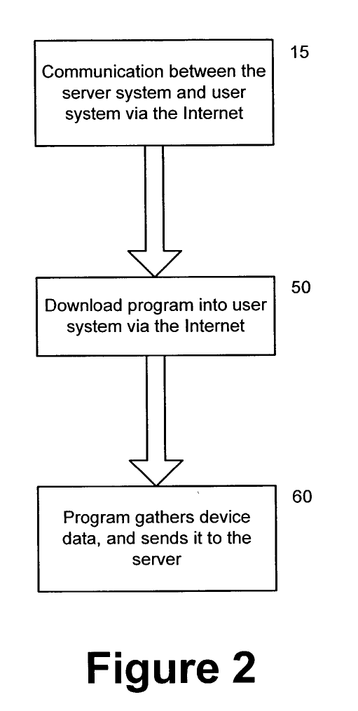

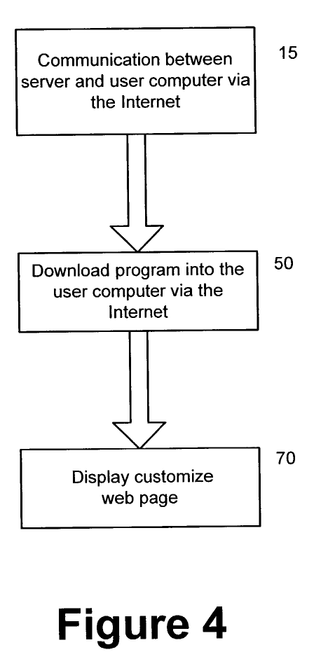

FIG. 2 shows a top-level functional operation of the system 10 for gathering data corresponding to a device 170 using the Internet. In state 15 a communication is established between a server system 180 and a user system 140. Then, the server 100 enables downloading of one or more programs to the user system 140 via the Internet. The program in state 60 operates to gather data from the device 170 communicating with the user system 140 and enables the data to be communicated via the Internet. An option before gathering data from the device 170 is to provide functionality that identifies the device 170 communicating with the user system 140. Flowcharts in FIGS. 4, 5 and 6 will provide further details of the functionality of the system 10 for gathering data corresponding to a device 170 using the Internet.

Before a detailed explanation is given of the flowcharts, a brief explanation of a general-purpose computer that can implement the system for gathering data corresponding to a device using the Internet is provided. The server 100 can be a general-purpose computer.

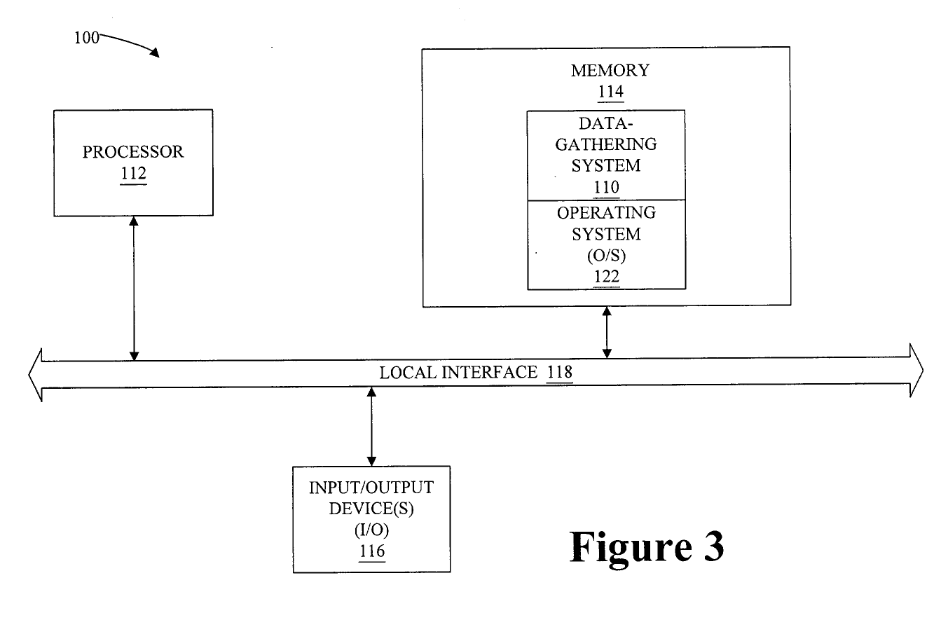

FIG. 3 shows an example of a general-purpose computer 100 that can implement the system of the present invention. The system of the invention can be implemented in software (e.g., firmware), hardware, or a combination thereof. In FIG. 3, the data-gathering system is denoted by reference numeral 110.

Generally, in terms of hardware architecture, as shown in FIG. 3, the computer includes a processor 112, memory 114, and one or more input and/or output (I/O) devices 116 (or peripherals) that are communicatively coupled via a local interface 118. The local interface 118 can be, for example but not limited to, one or more buses or other wired or wireless connections, as is known in the art. The local interface 118 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 112 is a hardware device for executing software, particularly that stored in memory 114. The processor 112 can be any custom made or commercially available processor, a central processing unit (CPU), an auxiliary processor among several processors associated with the computer 100, a semiconductor based microprocessor (in the form of a microchip or chip set), a macroprocessor, or generally any device for executing software instructions.

The memory 114 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 114 may incorporate electronic, magnetic, optical, and/or other types of storage media. Note that the memory 114 can have a distributed architecture, where various components are situated remote from one another, but can be accessed by the processor 112.

The software in memory 114 may include one or more separate programs, each of which comprises an ordered listing of executable instructions for implementing logical functions. In the example of FIG. 3, the software in the memory 114 includes the system for gathering data corresponding to device using the Internet in accordance with the present invention and a suitable operating system (O/S) 122. The operating system 122 essentially controls the execution of other computer programs, such as the data-gathering system 110, and provides scheduling, input-output control, file and data management, memory management, and communication control and related services.

The data-gathering system 110 is a source program, executable program (object code), script, or any other entity comprising a set of instructions to be performed. When a source program, then the program needs to be translated via a compiler, assembler, interpreter, or the like, which may or may not be included within the memory 114, so as to operate properly in connection with the O/S 122. Furthermore, the data-gathering system 110 can be written as (a) an object oriented programming language, which has classes of data and methods, or (b) a procedure programming language, which has routines, subroutines, and/or functions.

The I/O devices 116 may include input devices, for example but not limited to, a keyboard, mouse, scanner, microphone, etc. Furthermore, the I/O devices 116 may also include output devices, for example but not limited to, a printer, display, etc. Finally, the I/O devices 116 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

If the computer 100 is a PC, workstation, or the like, the software in the memory 114 may further include a basic input output system (BIOS) (omitted for simplicity). The BIOS is a set of essential software routines that initialize and test hardware at startup, start the O/S 122, and support the transfer of data among the hardware devices. The BIOS is stored in ROM so that the BIOS can be executed when the computer 100 is activated.

When the computer 100 is in operation, the processor 112 is configured to execute software stored within the memory 114, to communicate data to and from the memory 114, and to generally control operations of the computer 100 pursuant to the software. The data-gathering system 110 and the O/S 122, in whole or in part, but typically the latter, are read by the processor 112, perhaps buffered within the processor 112, and then executed.

When the data-gathering system 110 is implemented in software, as is shown in FIG. 3, it should be noted that the data-gathering system 110 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The data-gathering system 110 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the data-gathering system 110 of the system is implemented in hardware, the data-gathering system 110 can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The user computer 150 can also implement the hardware architecture as shown in FIG. 3. However, it should be noted that one or more programs in the data-gathering system 110 as explained above are downloaded and executed in the user computer 150.

The flow chart of FIG. 4 shows a user's perspective of the functionality of the system 110 for gathering data corresponding to a device 170 using the Internet. In FIG. 4, the flowchart begins with state 15 where a user 125 initiates communication between a server 100 and a user computer 150. A web page may be provided containing a description and brief instructions about what to do and what will happen before the user 125 downloads one or more programs for gathering data corresponding to a device 170 using the Internet. Then, in state 50, the user 125 downloads the program into the user computer 150 via the Internet. The program operates to identify a device 170 communicating with the user computer 150. When identifying the device 170, the program identifies the communication link of the device 170 with the user computer 150, such as IP address and port, and determines the identity of the device 170. After identifying the device 170 communicating with the user computer 150, the program gathers data from the device 170 and enables the data to be communicated via the Internet. The program can be a self-extracting executable file. Further, the program can be programmed to automatically uninstall itself from the user computer 150. Once the data is gathered from the device 170 and communicated via the Internet, a customized web page in state 70 is displayed on user computer 150.

The customized web page in state 70 provides the user 125 with various options. One option is to provide an executable program that is downloadable via the Internet to the user computer 150. The executable program can repair device 170 that is communicating with the user computer 150. Another option is to provide the user 125 with a web page that is showing the user 125 the data that was gathered from the program. Another option is to provide a web page that includes instructions to troubleshoot the device 170. Another option, the web page may include instructions to use another program to help troubleshoot the device 170.

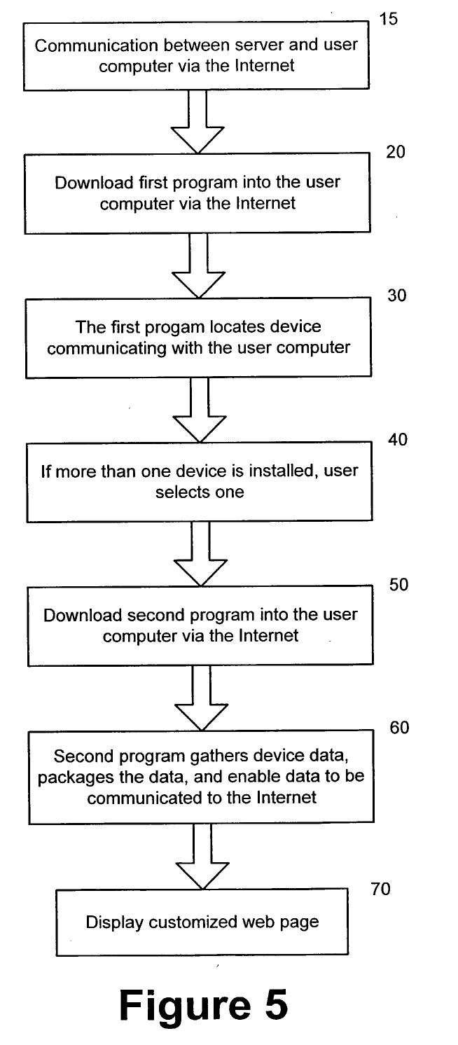

The flow chart of FIG. 5 shows the functionality of the system 10 for gathering data corresponding to a device 170 using the Internet. In this regard, each block represents a module, segment, or portion of code, which comprises one or more executable instructions for implementing the specified logical function(s). It should also be noted that in some alternative implementations, the functions noted in the blocks may occur out of the order. For example, two blocks shown in succession in FIG. 5 may in fact be executed substantially concurrently or the blocks may sometimes be executed in the reverse order, depending upon the functionality involved, as will be further clarified hereinbelow.

In FIG. 5, the flowchart begins with state 15 where a user 125 communicates with a server 100 via a user computer 150. The user 125 may then click on a link that takes him to a page where the program(s) may be downloaded. The page may also contain description and brief instruction about what to do and what will happen. In state 20, the user 125 clicks on an icon that starts an automatic downloading/extracting/executing process. A first program is downloaded and extracted into a temporary workspace. The first program in state 30 searches the user computer 150 for information on the communication link between the user computer 150 and a device 170, such as IP, port, etc. The first program in state 40 may encounter multiple installed devices 170 whereby the user 125 may select a device of interest. Then, the user 125 in state 50 downloads a second program into user computer 150 via the Internet. The second program in state 60 gathers data corresponding to the device 170 and packages the data into an XML format or any other compatible format. The second program then enables the data to be communicated via the Internet. The first and second programs may automatically de-install itself from the temporary workspace. A customized web page in state 70 is displayed on user computer 150. The customized web page in state 70 provides the user 125 with various options as explained above.

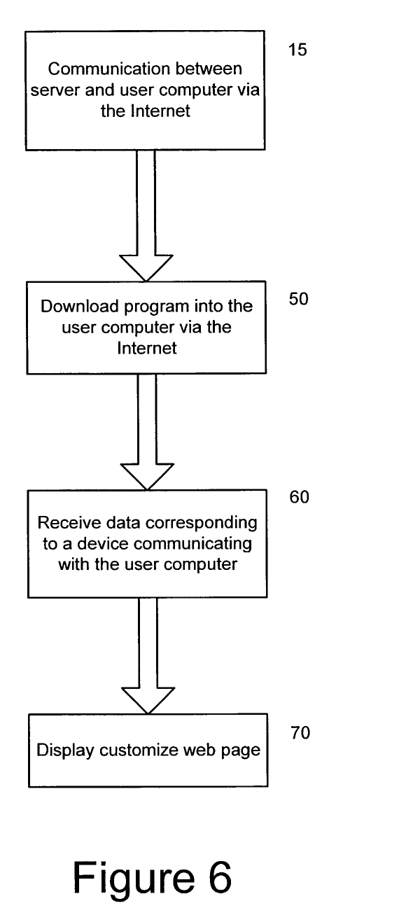

FIG. 6 is a flowchart of server's perspective of the functionality of the system 10 for gathering data corresponding to a device 170 using the Internet. In state 15, communication is established between a server 100 and a user computer 150. The server 100 enables downloading of one or more programs to the user computer 150 via the Internet. The program operates to identify a device 170 communicating with the user computer 150, gathers data from the device 170 and enables the data to be communicated via the Internet. The program identifies the device 170 by identifying the communication link of the device 170 communicating with user computer 150, such as IP address and port, and determining the identity of the device 170. In state 55, the server 100 receives the data corresponding to the device 170 via the Internet. From the data received, the server 100 in state 70 displays a customized web page. The customized web page in state 70 provides the user 125 with various options as explained above.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A method for gathering data corresponding to a device using the Internet, the method comprising the steps of:
downloading a first program and a second program to a computer via the Internet, the first program being operative to identify the device communicating with the computer, the second program being operative to gather data from the device identified and enable the data to be communicated via the Internet.

2. The method of claim 1, further comprising the step of uninstalling at least one of the first program and the second program automatically in response to the data being communicated.

3. The method of claim 1, wherein one of the first program and the second program is a self-extracting executable.

4. The method of claim 1, wherein the device is one of a printer, scanner, fax machine, and copying machine.

5. A method for gathering data corresponding to a device using the Internet, the method comprising the steps of:
enabling downloading a first program to a computer via the Internet, the first program being operative to gather data from the device communicating with the computer and enable the data to be communicated via the Internet.

6. The method of claim 5, further comprising the step of identifying the device communicating with the computer before the first program operates to gather data from the device and enable the data to be communicated via the Internet.

7. The method of claim 6, wherein the step of identifying the device communicating with the computer further comprises enabling downloading of a second program, the second program being operative to identify the device.

8. The method of claim 7, wherein the second program is operative to identify a communication link of the device communicating with the computer.

9. The method of claim 6, further comprising the step of selecting the first program configured to correspond directly to the device identified.

10. The method of claim 7, further comprising the step of uninstalling at least one of the first program and the second program automatically in response to the data being communicated.

11. The method of claim 5, wherein the device is one of a printer, scanner, fax machine, and copying machine.

12. The method of claim 7, wherein one of the first program and the second program is a self-extracting executable.

13. The method of claim 5, further comprising the step of one of displaying an HTML form on the computer and enabling downloading of an third program to maintain, troubleshoot and/or repair the device.

14. A system for gathering data corresponding to a device using the Internet, the system comprising:
a data-gathering system including a first program and a second program, the first program and the second program being downloadable to a computer via the Internet, the first program being operative to identify the device communicating with a computer, the second program being operative to gather data from the device and enable the data to be communicated via the Internet.

15. The system of claim 14, wherein at least one of the first program and second program automatically uninstalls in response to the data being communicated.

16. The system of claim 14, wherein at least one of the first program and second program is a self-extracting executable.

17. A system for gathering data corresponding to a device using the Internet, the system comprising:
a data-gathering system comprising a first program, the first program being enabled to be downloaded to a computer via the Internet, the first program being operative to gather data from the device communicating with the computer and enable the data to be communicated via the Internet.

18. The system of claim 17, wherein the data-gathering system further comprises a second program, the second program being enabled to be downloaded to a computer via the Internet, the second program being operative to identify the device communicating with the computer before the first program is enabled to be downloaded.

19. The system of claim 18, wherein the second program is operative to identify a communication link of the device with the computer.

20. The system of claim 18, wherein the data-gathering system selects the first program after the second program identifies the device communicating with the computer.

21. The system of claim 18, wherein one of the first program and second program automatically uninstalls in response to the data being communicated.

22. The system of claim 18, wherein at least one of the first program and the second program is a self-extracting executable.

23. A computer-readable medium having a computer program for gathering device data using the Internet, the computer-readable medium comprising:
logic configured to identify a device communicating with a computer,
logic configured to gather data from the device; and
logic configured to communicate the data from the computer to a server.

24. The computer readable medium of claim 23, further comprising logic configured to uninstall the program automatically in response to the data being communicated.

25. The system of claim 23, further comprising logic configured to identify a communication link of the device with the computer.

26. The system of claim 23, further comprising logic configured to download an HTML form for display on the computer.
